(19) United States
(12) Patent Application Publication
(10) Pub. No.: US 2012/0302390 A1
(43) Pub. Date: Nov. 29, 2012

(54) Bidirectional hub motor with unidirectional two-speed output

(75) Inventors: Justin Bruce Lemire-Elmore, Vancouver (CA); Michael Viner-Smith, Vancouver (CA); Zev Alexander Thompson, Vancouver (CA)

(73) Assignee: Mr. Zev Alexander Thompson, Vancouver (CA)

(21) Appl. No.: 13/200,708

(22) Filed: Sep. 29, 2011

Related U.S. Application Data
(60) Provisional application No. 61/404,272, filed on Oct. 1, 2010.

(51) Int. Cl. B60B 27/04

(52) U.S. Cl. 475/149

(57) ABSTRACT

A two-speed bidirectional hub motor includes an electrically driven hub, including an electrical motor, oppositely aligned one-way bearings, and a planetary gear system connected to the electrical motor. A fixed shaft is connected to the stator of the electrical motor. The first of two one-way bearings connects the electrical motor to the planetary gear system, and the second one-way bearing connects the electrical motor to the hub casing. When the rotor is electrically activated to spin in the forwards direction, the second one-way bearing engages the hub casing and rotates the wheel forwards at high speed. When the rotor is electrically activated to spin in the reverse direction, the first one-way bearing engages the planetary gearing system, rotating the wheel forward at lower speed by a gear reduction. This design gives two-speed output without a transmission.

### FIELD OF THE INVENTION

This invention relates generally to electrical motors and generators and more specifically to a wheel hub containing an integrated motor/generator with an integral two-speed transmission. The most common application is likely to be in electric bicycles, motor scooters, and other electric vehicles, but the utility of this invention is not limited to these fields.

### BACKGROUND OF THE INVENTION

2.1 Electric bicycles and scooters are generally driven by an electrical motor, powered by a battery, and regulated by an electronic power controller. One motor variety used in this typed of vehicle is known as the direct drive hub motor, in which the rotor of the electric motor also directly serves as the driving wheel of the vehicle. U.S. Pat. No. 4,450.915 illustrated characteristic examples of this types. This motor design has the advantage of simplicity: a minimum of moving parts, not mechanical transmission losses, a minimum of material costs, and ease of incorporation into a vehicle design. These factors make it a popular motor type used in electric bicycles and scooters. However, there are three disadvantages to this design. Firstly, the hub motor always has slight electromagnetic drag since it cannot be disengaged from the turning wheel. Secondly, the hub motor can only operated at a fixed 1:1 ratio between the motor and the wheel, so the motor's electrical efficiency is good only at the high end of the speed range. Finally, the ratio of torque to weight is poor, requiring a large and heavy motor to achieve adequate performance.

2.2 A common solution to address two of these issues is the incorporation of a fixed-ratio gear reduction in the motor housing. Typical examples of a geared hub motor include U.S. Pat. Nos. 4,246,777, 5,633,544, 6,276,475, 6,355,996, 6,321,863, and 6,974,399. These motors have a small, high speed motor inside the hub that transmits torque to the wheel through a fixed-gear reduction. This allows for a better ratio of torque output to weight. Furthermore, the gear mechanism usually incorporates a one-way bearing so that the wheel's rotation does not cause the motor itself to rotate, eliminating the drag discussed in SECTION 2.1. The disadvantage of these geared hub motors is that the gearing is in a fixed ratio; at high speeds where the gearing is less important, it still causes mechanical loss, audible noise, and increased gear wear. Additionally, there is no capability to alter the gear ratio for optimum motor efficiency across the entire speed range.

2.3 Another solution is to couple the electric motor to a multi-speed mechanical transmission that is in turn coupled to the wheel. Examples of this type include U.S. Pat. No. 7,261,175. With a multi-speed transmission allowing for gear changes, the motor can spin at an efficient RPM over a wide range of drive speeds, increasing the average efficiency when compared to a fixed-ratio reduction between motor and wheel. The disadvantage of this design is that it adds considerable mechanical complexity in comparison to a hub motor as discussed in SECTION 2.1 or 2.2. The electric motor must be externally mounted to the vehicle frame and coupled via belt, chain, shaft, or gear drives to a transmission box that drives the wheel.

2.4 An ideal solution would appear to be incorporation of the multi-speed gearing inside the hub, in the same general form factor of the fixed-gear-reduction motor. U.S. Pat. No. 7,150,340 demonstrates exactly this, where the hub motor has three available speed modes and an elaborate method for shifting the motor between the different speed options. This approach, while overcoming the deficiencies of single speed hub motor designs and the installation complexity of an external drive transmission, introduces substantial amounts of internal complexity. Mechanical actuators are required to effect gear changes, with multiple moving parts and pinions.

### BRIEF SUMMARY OF THE INVENTION

A hub motor capable of operating at multiple speed ratios without the complexity of a conventional transmission, without gear-induced losses at high speeds, and without a mechanical gear shifter creates an entirely new class of electrical device. Hereafter, for sake of brevity, the “bidirectional hub motor with unidirectional two-speed output” shall also be known as the Bicyclic Hub.

The Bicyclic Hub is a geared hub motor that has an intrinsic two-speed internal transmission between the motor and the wheel The act of electronically reversing the direction of the motor effects two different output speed ranges based on two one-way bearings that lock and freewheel oppositely.

By spinning the motor opposite to the desired wheel direction, the first one-way bearing couples the output to an epicyclic gear reduction exactly like the geared hub motors of SECTION 2.2. The second one-way bearing spins freely. This allows for a high torque-to-weight drive mode.

By spinning the motor in the same direction as the desired wheel direction, the second one-way bearing is locked and the motor output is coupled to the hub casing, effecting direct-drive mode as discussed in SECTION 2.1, while the torque path through the epicyclic gear reduction is disconnected due to the freewheeling action of the first one-way bearing. This provides for a silent, efficient high-speed mode, without transmission losses or gear wear.

A variety of freewheel types could be employed instead of one-way bearings provided that they allow free rotation in one direction and lock in reverse, including but not limited to a sprag clutch or pawl-type freewheel The mounting positions of each one-way bearing can vary in any manner that achieves the desired unidirectional linkage.

Unlike the multi-speed transmissions in SECTION 2.3, the Bicyclic Hub's transmission is entirely contained within the hub wheel, so as with other hub motors of SECTION 2.1 and 2.2, it is simple to incorporate into a vehicle design. Unlike the multi-speed transmissions of both SECTION 2.3 and SECTION 2.4, there is no mechanical shifting mechanism, actuator, or other internal moving parts required to change gears. Switching between the two speed ranges can be done entirely electronically and suddenly, even while the motor is under load.

The Bicyclic Hub could be laced in a conventional bicycle wheel with spokes, or could be molded to the hub directly, as is common with smaller diameter scooter wheels. Although the Bicyclic Hub is solely discussed here for use on electric bicycles and scooters; other uses include, but are not limited to: use on a wheelchair, cargo trolley, and other land/water/air vehicles, as well as non-vehicular such as carnival rides, wind turbines, or conveyor belts.

In its most basic embodiment, the Bicyclic Hub has a limitation that it will lock if rotated in reverse, such as when backing up a vehicle. If a limited amount of reverse rotation is required (such as backing up a bicycle into a parking space) then either of the one-way bearings could incorporate a clock spring, slotted mechanism, or use any other technique that allows a small amount of backward mobility before the wheel locks. Indefinite backward motion at low speed could be achieved using a centrifugal clutch in conjunction with one of the one-way bearings.

### PRIOR WORK

U.S. Pat No. 4,137,798 describes a two-speed drive apparatus, with a second speed enabled when the motor is driven in reverse. The drive mechanism is done entirely with an over-running clutch, but along a shaft used for high-voltage AC. The motor is not integrated into the drive apparatus.

U.S. Pat No. 4,249,116 describes a standard brushless motor controller. Some variant of this type of controller moderates power in basically every hub-motor-driven electric vehicle.

U.S. Pat No. 6,974,399 describes a standard geared, one-way-bearing equipped, single-speed hub motor.

Also cited: U.S. Pat No. 5,633,544, Wheel motor;

U.S. Pat No. 5,450,915, Electric motor-in-wheel;

U.S. Pat No. 6,276,475, Wheel hub electric motor and transmission drive unit;

U.S. Pat No. 6,355,996, Modular motorized electric wheel hub assembly for bicycles and the like;

U.S. Pat No. 6,321,863, Hub motor for a wheeled vehicle;

U.S. Pat No. 7,261,175, Power assisted bicycle.

### BRIEF DESCRIPTION OF THE DRAWINGS

FIG. 1 is the exploded view to show the primary components of Bicyclic Hub;

FIG. 2 is the cross sectional view to show the Bicyclic Hub fully constructed;

FIG. 3 is the 3D cross sectional view to show the Bicyclic Hub fully constructed.

### DETAILED DESCRIPTION OF THE INVENTION

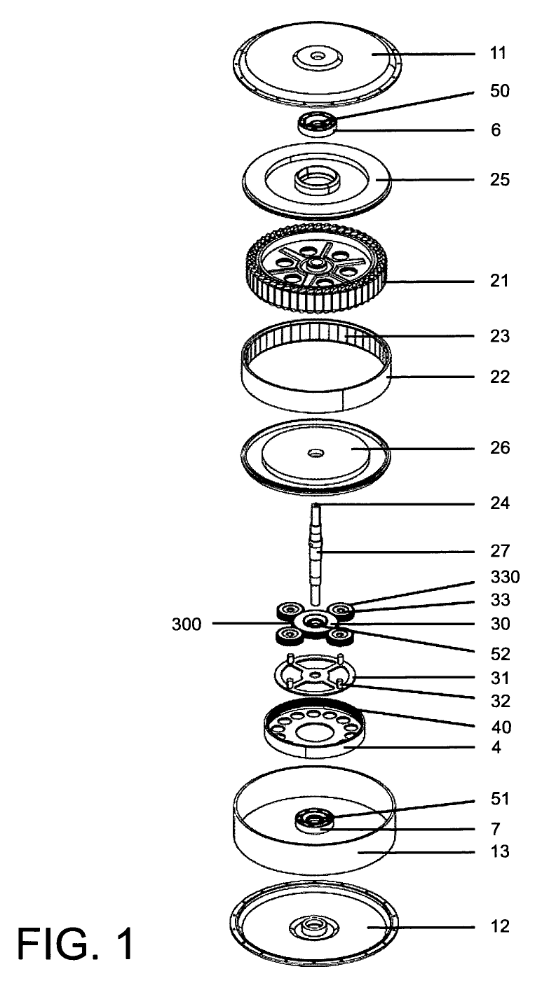

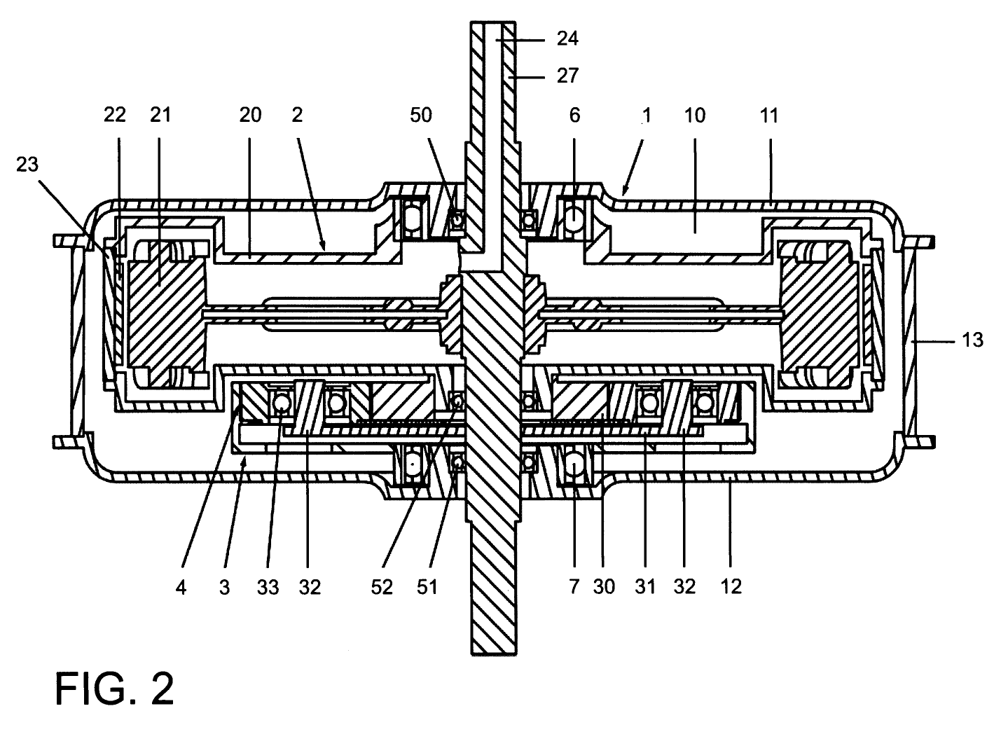

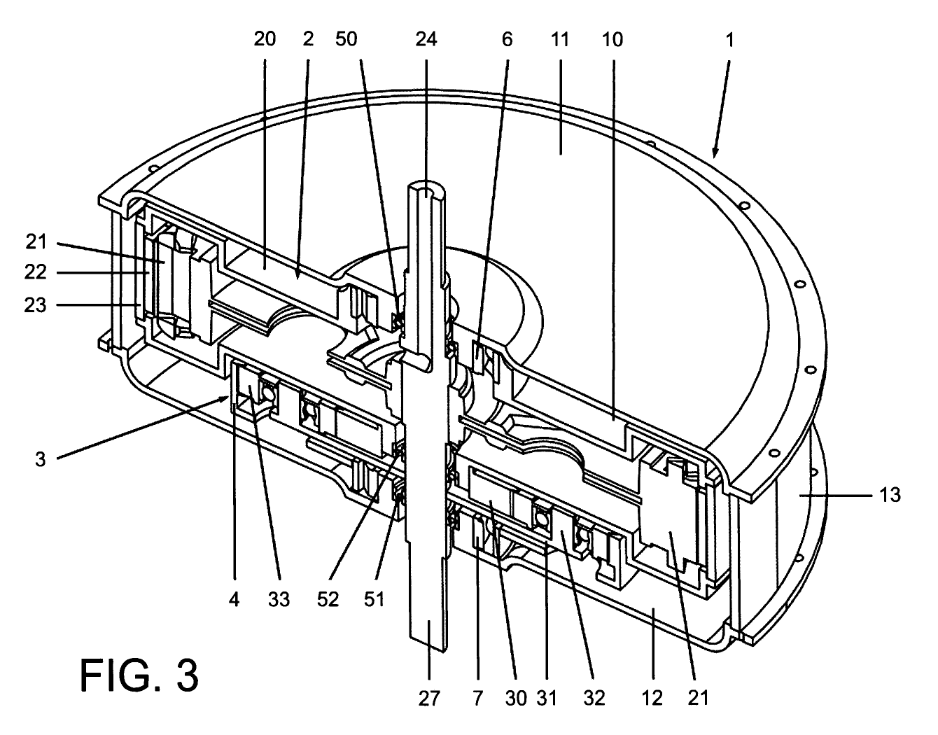

Referring to FIGS. 1 to 3, the Bicyclic Hub presently described comprises an enclosed hub unit 1, with a chamber therein 10 and side covers 11, 12 that seal the chamber in conjunction with a hub shell 13. An electrical mechanism 2 is housed in the chamber 10, receiving an electrical current through an axle wire exit 24 so as to drive the hub 1 and comprises an electrical motor 20, including a stator 21 and a rotor ring 22 with magnets 23 lining it, and is rotated relative to the stator 21. A single fixed shaft 27 is connected to the stator 21 and drives the planetary gearing assembly 3. The electrical mechanism 2 is mounted on a one-way bearing 6 that is affixed to the motor-side hub side cover 11.

The planetary gearing system 3 includes a sun gear 30, a support board 31 that is affixed to the axle 27, and a plurality of planet gears 33 mounted on pivotal rods 32 that protrude from the support board 31. The sun gear 30 is matched to the planetary gears 33, with the planetary gear teeth 330 meshing with the sun gear teeth 300.

The planetary gears 33 are matched to a ring gear mount 4, with the planetary gear teeth 330 meshing with the ring gear teeth 40. The ring gear mount 4 is mounted on a one-way bearing 7. The one-way bearing 7 is mounted to the gear-side hub side cover 12.

Depending on the direction of rotation of the internal motor 2, the Bicyclic Hub 1 is driven either through the locked rotor-side one-way bearing 6 or is driven through the planetary gearing system 3, the ring gear 4, and the locked gear-side one-way bearing 7.

The electrical mechanism 2, one-way bearings 6, 7, planetary gear assembly 3, and ball bearings 50, 51, 52 are coaxial on the axle 27. The electrical mechanism's side covers 25, 26 are affixed to the rotor's magnet ring 22 and comprise a single structure rotating on the axle 27 via a ball bearing 52 and a one-way bearing 6.

The hub casings 11, 12 are each affixed to a hub shell 13 and are co-rotational. They are held coaxial to the Bicyclic Hub axle 27 by ball bearings 50, 51.

While we have shown and described the embodiment in accordance with the present invention, it should be clear to those skilled in the art that further embodiments may be made without departing from the scope of the present invention.

What is claimed is:

1. An electrically driven hub comprising:
an enclosed hub unit 1, with a chamber defined therein 10 and covers 11, 12 connected to the hub 1, and where the covers 11, 12 are linked together either through the hub shell 13 bolted to the side covers 11 and 12 or solely via the connection to the wheel or rim;
an electrical mechanism 2 received in the chamber 10 so as to, in conjunction with the rotor 22 fitted between two plates 25, 26, drive the hub 1 and comprising a stator 21 affixed to the axle 27 and a rotor 22 that rotates relative to the stator 21 and is linked to the rotor-side side cover 11 by a one-way bearing 6;
a planetary gear system 3, consisting of a sun gear 30 affixed to the electrical mechanism 2, planetary gears 33 affixed to a support board 31 by a plurality of pivotal rods 32 that extend from the board 31;
a ring gear 4 that rotates on a one-way bearing 7 relative to the gear-side hub side cover 12;

2. The hub as claimed in claim 1, where the output torque of the rotor 22 is transmitted to the motor casing 11, 12 through either the sun gear 30, which drives the planet gears 33, ring gear 40 and ring gear assembly 4, and gear-side hub casing 12, or, when the electrical mechanism 2 is rotated oppositely, is transmitted to the one-way bearing 6 and rotor-side hub side cover 11.

3. An electrically driven hub comprising:
an enclosed hub unit 1, with a chamber defined therein 10 and covers 11, 12 connected to the hub 1 to seal the chamber 10, and where the covers 11, 12 are linked either through the hub shell 13 bolted to the side covers 11 and 12 or solely via the connection to the wheel or rim;
an electrical mechanism 2 received in the chamber 10 through the axle wire exit 24 so as to, in conjunction with the rotor 22 fitted between two plates 25, 26, drive the hub 1 and comprising a stator 21 affixed to the axle 27 and a rotor 22 with a ring of magnets 23 that rotates relative to the stator 21 and axle 27 and is mounted on the axle 27 by a one-way bearing 6;
a planetary gear system 3, consisting of a sun gear 30 affixed to the side cover of the electrical mechanism 26, planetary gears 33 affixed to a support board 31 by a plurality of pivotal rods 32 that extend from the board 31, that is itself affixed to the axle 27;
a ring gear carrier 4 with a ring gear 40 that rotates on a one-way bearing 7 relative to the axle 27 and is mounted to the gear-side hub side cover 12 by the one-way bearing 7;
where the output torque of the rotor 22 is transmitted to the motor casing 11, 12 through either the sun gear 30, which drives the planet gears 33, ring gear 40 and ring gear assembly 4, and gear-side hub casing 12, or, when the electrical mechanism 2 is rotated oppositely, is transmitted to the one-way bearing 6 and rotor-side hub side cover 11.
